(19) United States
(12) Patent Application Publication
(10) Pub. No.: US 2011/0311946 A1
(43) Pub. Date: Dec. 22, 2011

(54) MUTALLIC DENTAL IMPLANTS AND PROSPHETIC APPLIANCE HAVING COLORED CERAMIC SURFACES

(76) Inventors: Irena Sailer, Zurich (CH); John Ricci, Middletown, NJ (US)

(21) Appl. No.: 12/736,019

(22) PCT Filed: Mar. 5, 2009
(86) PCT No.: PCT/US2009/001408

§ 371 Date: Dec. 6, 2010

Related U.S. Application Data
(60) Provisional application No. 61/068,324, filed on Mar. 5, 2008.

(51) Int. Cl. A61C 8/00

(52) U.S. Cl. 433/173; 433/201.1

(57) ABSTRACT

The present invention provides a dental, oral or maxillofacial implant, implant component and any other prosthetic appliance having an oxide ceramic coating on a metal surface. The oxide ceramic coating is preferably colored similar to the color of the surrounding tissues (e.g. similar to the color of bone, teeth or of mucosa). The oxide ceramic coating may comprise any oxidizable metal. Preferably, the oxide ceramic coating comprises zirconium or a zirconium alloy. The oxide coating is of a thickness that exhibits the desired color. Preferably the oxide ceramic coating is at least 20, 30, 50, 75, 100, 120 or more μm thick. The prosthetic implant appliances of the invention may be an abutment, ball attachment, bar, telescopic component or other implant components (e.g. magnetic attachments), or the implant itself trespassing the mucosa. The prosthetic appliances may be used for implant reconstructions. Furthermore, they may be used for making tooth-borne reconstructions like esthetic root posts, crowns/bridges and removable reconstructions. They may also be used for extraoral applications like implant-retained prostheses or hearing aids, or other maxillofacial applications. The dental, oral or maxillofacial implants, abutments or the prosthetic appliances combine the excellent esthetics and good biocompatibility of ceramics with the advantageous mechanical properties of metals. The invention also provides a method of making dental, oral or maxillofacial implant, implant component or a prosthetic device by oxidizing the surface of the metal., as well as the products made thereby.

### FIELD OF THE INVENTION

This invention relates to prosthetic appliances such as dental implants having colored oxidized ceramic surfaces and methods of making the same.

### BACKGROUND

Dental implants are a very successful and predictable treatment means for the replacement of missing teeth. Usually, they are metallic cylindrical or tapered screws that have to be fixed into the patient's jawbone and can be used for the fixation of fixed or removable reconstructions. For this, special prosthetic implant components (abutments, attachments, bars etc.) are needed, which connect the “intra-bony” implant with the “intra-oral” reconstruction. These prosthetic components trespass the mucosal barrier and are visible in the oral cavity. Traditionally, metals like commercially pure titanium (Ti) and Ti alloys are used for making dental implants and implant components such as abutments, etc. due to their excellent material stability and their good biological integration. Their load bearing functionality is well documented in numerous studies. However, in addition to good stability, aesthetic factors are increasingly important. It is desirable to provide a harmonious reconstruction that cannot be distinguished from natural teeth by the naked eye.

Unfortunately, metals are undesirable from an esthetic perspective because of their grey color. Since the upper implant or abutment may be visible near the gingival margin, the grey color of the implant or the abutment may lead to a discoloration of the peri-implant mucosa. One approach to overcome this problem is additional surgical interventions to thicken the covering tissues (augmentation/thickening of the bone and/or the mucosa) and hide the metal. However, surgical procedures are invasive and always accompanied with biological and surgical risks.

A less invasive approach to reduce the discoloration is to use ceramic abutments made of high strength oxide ceramics like alumina and zirconia. Zirconia exhibits superior material stability compared to all other ceramics and is used for various indications as the “ceramic material of choice” today. The ceramic components are esthetically advantageous compared to titanium because of their tooth-like color, and mucosa shadowing is reduced by their enhanced translucency. Their biocompatibility is comparable to titanium. However, ceramic abutments are difficult and expensive to fabricate, and the grey color of the titanium implant upper part may still show through and lead to a grayish discoloration.

All-ceramic implants made of zirconia designed in one piece incorporating the abutment have been introduced recently. Making these all ceramic implants is expensive and difficult, and they suffer from several technical problems. Although their whitish appearance certainly is an esthetic benefit, fractures of the ceramic implant is likely to occur in clinical loading situations due to fatigue and slow crack propagation. After fracture of the implant, surgical removal of the osseointegrated remnants of the implant is necessary, resulting in an extensive osseous defect. Thereafter, several surgical steps are needed to rebuild the defect and insert a new implant.

One piece design of zirconia implants is prosthetically disadvantageous. It is better to separate the implant part from the abutment part in order to provide easy clinical handling. Previously, a change of the design from one-piece to two-piece ceramic implants has not been possible because the implant components cannot be screwed together like metallic implants and abutments. Metals are ductile and can be elastically deformed. This feature is utilized in the mechanics of screw fixation for the wedging of the components, exhibiting tensile load on the threads of both screws and implants. Ceramics are brittle, and therefore very weak on tensile stresses. A screw cannot be used to fixate implant components at ceramic implants. Hence, a two-piece design of ceramic implants has been difficult or impossible to accomplish leading to a very limited applicability.

Finally, it was demonstrated that not only grey but also bright white is not the ideal color for the components trespassing the mucosa. White has a “bleaching” effect on the mucosa, resulting in a pale rather than a grayish discoloration. Recently, pink or light pink have been demonstrated to be a good match for abutments components. In order to provide implants and implant components having both excellent material stability and esthetic properties, there is need for materials combining the stability and ductility of metal and the esthetic properties of ceramics. For optimal esthetic results the color of the surface of the implants should resemble the color of bone, and the color of the implant abutments and prosthetic appliances should either resemble the color of the surrounding mucosa or the color of teeth.

The formation of a ceramic oxide coating on zirconium or zirconium alloys was described by Watson, U.S. Pat. No. 2,987,352, Davidson, U.S. Pat. No. 5,037,438, Hunter, U.S. Pat. No. 6,447,550, and Hunter, U.S. Patent Application No. 2003/0033020. In each instance, a ceramic surface was developed for orthopedic implants such as those used to replace knee, hip and shoulder joints. The primary objective of the ceramic oxide coatings in each instance was to increase the wear resistance and reduce the metal ion release of the implants. Therefore, a highly wear resistant, thin, dense and low friction coating was developed. However, the ceramic oxide coatings are black or blue-black in color. There are two main ways to provide ceramic coatings on zirconium metals. The first is to apply ceramic coatings to the metal e.g. by physical vapor deposition or by chemical vapor deposition. However, the coatings applied onto a metal surface may be non-uniform and adhere poorly. (Rieu, Clinical Materials, 1993, 12:227-235; Hunter et al., Journal of ASTM International, 2005 2(7):1-14) The second method to accomplish an oxide ceramic coating is by surface oxidation, whereby oxygen may be diffused into the metal substrate itself. Ceramic oxide coatings with good adherence and integrity suitable for use in dental applications would be desirable.

### BRIEF SUMMARY OF THE INVENTION

The present invention features in a first aspect a dental, oral or maxillofacial implant, implant component or other prosthetic appliance having an oxide ceramic coating on a metal surface. The oxide ceramic coating is preferably colored similar to the color of the surrounding tissues (e.g. similar to the color of bone, teeth or of mucosa). The oxide ceramic coating may comprise any oxidizable metal. Preferably, the oxide ceramic coating contains zirconium or a zirconium alloy. The oxide coating is of a thickness that exhibits the desired color. Preferably the oxide ceramic coating is at least 20, 30, 75, 100, 120 or more μm thick. The prosthetic implant appliances of the invention may be an abutment, ball attachment, bar, telescopic component or other implant component (e.g. magnetic attachments), or the implant itself trespassing the mucosa. The prosthetic appliances may be used for implant reconstructions. Furthermore, they may be used for making tooth-borne reconstructions like esthetic root posts, crowns/bridges and removable reconstructions. They may also be used for extraoral applications like implant-retained prostheses or hearing aids, or other maxillofacial applications. The dental, oral or maxillofacial implants, abutments or the prosthetic appliances combine the excellent esthetics and good biocompatibility of ceramics with the advantageous mechanical properties of metals. The metallic core exhibits optimal material stability, whereas the ceramic surface esthetically adapts the color to the individual surrounding tissues. The color of the ceramic may be for example, white, creamy-white, brownish, orange or yellowish resembling bone or tooth substance, or reddish and pinkish resembling mucosa. The metal may be chosen to provide the desired color. The metal may be any oxidizable metal or alloy, such as a metal or alloy containing Zi, Ti, Nb, Fe, etc. In some embodiments, the metal or alloy is Zirconium, particularly preferred pure Zi (ZIRCADYNE 702) and the Zi-alloy (ZIRCADYNE 705). The oxidation of a Zr/Y-alloy provides a whitish surface oxide, and the oxidation of a Zr/Ce-alloy provides a creamy-whitish surface oxide. In other embodiments, zirconium alloys such as Zr/Si, Zr/Ti, Zr/Al, Zr/Mg, Zr/Fe (ZIRCADYNE 704) and Zr/N are used. Since the dental, oral or maxillofacial implants, abutments or the prosthetic appliances and components thereof are metallic on the inside, the parts can be designed with separate parts to be joined together (e.g. screwed or glued, etc.), simplifying the clinical procedures.

An oxide ceramic coating provides many advantages since the metal surface is converted, and the ceramic oxide is grown in situ. The quality and adherence of the coating generally is superior to the one of deposited ceramic coatings. An air oxidation method as is preferably used in the present invention produces a controlled, uniformly thick, firmly adhering ceramic oxide coating. The oxidation can also be accomplished by other methods, such as air, steam or water oxidation, or oxidation in a molten salt bath. Oxidation in a gaseous atmosphere can have an influence on the oxidation and on the color of the oxide ceramic coating. An oxide ceramic surface may increase the mechanical stability of the metal substrate. The ceramic coating may be achieved exhibiting various kinds of surface morphologies, such as smooth, rough, textured or grooved surface, and the like as is appropriate or most desirable for the implant or device.

In a second aspect, the invention provides a method of making a dental, oral or maxillofacial implant, implant component or a prosthetic device by oxidizing the surface of the metal. In some embodiments, the morphology of the surface is modified prior to oxidation. In other embodiments, the metal surface morphology is modified by one or more of the following steps: etching, grooving, laser texturing, machining, SLA (sandblasted+acid etched), TPS (titan plasma spray), or anodizing the metal. In some embodiments the modification of the metal surface morphology is accomplished by applying acid such as, for example, a 1% or a 5% concentrated hydrofluoric acid for a time period that may be, for instance, 10, 20 or 30 seconds and thereby etching the surface. The metal may be chosen to provide the desired color. The metal may be any oxidizable metal or alloy, such as a metal or alloy containing Zi, Ti, Nb, Fe, etc. In some embodiments, the metal is Zirconium, such as substantially pure Zi (ZIRCADYNE 702) or the Zi-alloy (ZIRCADYNE 705). In other embodiments, the metal is a Zr/Y-alloy, a Zr/Ce-alloy or one or more alloys selected from among Zr/Si, Zr/Ti, Zr/Al, Zr/Mg, Zr/Fe (ZIRCADYNE 704) and Zr/N. The oxidizing may be performed at temperatures higher than 400° C., 500° C., 600° C., 700° C., or 800° C. but lower than 900° C. for time periods between 1 and 500 hours, preferably, between 3 and 200 hours, between 6 and 200 hours, or between 20 and 150 hours. In many instances, the oxidizing is performed for at period of at least 5, 10, 15, 20, 25, 30, 40 or 50 hours. The oxidizing is performed until the surface of the metal reaches substantially the color of the surrounding tissues. In some embodiments, the oxidizing is performed until a color matching the color of teeth or bone, for example, a whitish or creamy or yellowish or brownish or orange or creamy-whitish color is obtained on the surface of the metal. In other embodiments, the oxidizing is performed until a color matching the color of mucosa, for example, a reddish or a pinkish color is obtained on the surface of the metal. Also, in some embodiments, the oxidizing is performed until a ceramic coating is produced that is at least 20, 30, 50, 75, 100, 120 or more μm thick.

In a third aspect, the invention provides a dental, oral or maxillofacial implant, implant component or prosthetic device produced by oxidizing the surface of the metal. In some embodiments, the morphology of the surface is modified prior to oxidation. In other embodiments, the metal surface morphology is modified by one or more of the following steps: etching, grooving, laser texturing, machining, SLA (sandblasted+acid etched), TPS (titan plasma spray), or anodizing the metal. In some embodiments the surface modification of the metal (i.e. etching) is performed by applying an acid such as, for example, a 1% or a 5% concentrated hydroflouric acid for a time period that may be, for instance, 10, 20 or 30 seconds. The oxide ceramic coating may be accomplished on any oxidizable metal. The metal may be chosen to provide the desired color. The metal may be any oxidizable metal or alloy, such as a metal or alloy containing Zi, Ti, Nb, Fe, etc. In some embodiments, the metal is Zirconium, such as substantially pure Zi (ZIRCADYNE 702) or the Zi-alloy (ZIRCADYNE 705). In other embodiments, the metal is a Zr/Y-alloy, a Zr/Ce-alloy or one or more alloys selected from among Zr/Si, Zr/Ti, Zr/Al, Zr/Mg, Zr/Fe (ZIRCADYNE 704) and Zr/N. The oxidizing may be performed at temperatures higher than 400° C., 500° C., 600° C., 700° C., or 800° C. but lower than 900° C. for time periods between 1 and 500 hours, preferably, between 3 and 200 hours, between 6 and 200 hours, or between 20 and 150 hours. In many instances, the oxidizing is performed for a period of at least 5, 10, 15, 20, 25, 30, 40 or 50 hours. In some embodiments, the oxidizing is performed until the surface of the metal reaches substantially the color of the surrounding tissues. In some embodiments, the oxidizing is performed until a color matching teeth or bone, for example a whitish or creamy or yellowish or brownish or orange or creamy-whitish color is obtained on the surface of the metal. In other embodiments, the oxidizing is performed until a color matching mucosa, for example a reddish or pinkish color is obtained on the surface of the metal. Also, in some embodiments, the oxidizing is performed until a ceramic coating is produced that is at least 20, 30, 50, 75, 100, 120 or more μm thick.

### BRIEF DESCRIPTION OF THE DRAWINGS

FIG. 1 demonstrates a cross-sectional view of an original grey titanium implant and abutment (left), and the esthetic improvement with colored, ceramic surfaces of a metallic implant, an abutment and a prosthetic appliance, i.e. a crown (right).

### DETAILED DESCRIPTION

The present invention provides metallic dental, oral or maxillofacial implants, implant components and other prosthetic appliances having an esthetically colored ceramic surface, substantially matching the color of the surrounding tissues. This kind of surface can be achieved by oxidizing a metal or an alloy, preferably with a thickness of the resulting ceramic coating of a minimum of 20 μm and up to 100 μm and more. Preferred metal or alloy is Zirconium, particularly preferred pure Zi (ZIRCADYNE 702) and the Zi-alloy (ZIRCADYNE 705), both of which have good mechanical and biocompatibility properties. Based on current evidence, the oxidation of the Zr/Y-alloy should lead to a whitish surface oxide and the oxidation of the Zr/Ce-alloy should lead to a creamy-whitish surface oxide, making both alloys useful for the above mentioned applications. Besides these metals other zirconium alloys like combinations of Zr/Si, Zr/Ti, Zr/Al, Zr/Mg, Zr/Fe (ZIRCADYNE 704) and Zr/N may be applicable. In general, oxidation methods like air, steam or water oxidation, or oxidation in a molten salt bath can be applied. These processes ideally provide a tightly adherent, uniformly thick zirconium oxide film.

The surface of the metal can be morphologically modified. For instance metals can be etched prior to oxidation by means of a diluted hydrofluoric acid or with concentrations of 1% to 5% being most appropriate, laser textured and grooved or roughened by machining or grit-blasting. Any surface modification of the metal is appropriate. The etching procedure with the low concentration acid generally leads to a uniform and controlled rough surface topography, enhancing a uniform oxide formation. Alternatively to hydrofluoric acid other acids like nitric acid may be used. Surface modifications like e.g. laser texturing and grooving accelerate the growth of the ceramic oxide. Temperatures and time periods of oxidation depend on the used metal or alloy and the oxidation method. In air oxidation the metals are oxidized at temperatures higher than 400° C. but lower than 900° C. for time periods between 3 and 150 hours. A pinkish surface can preferably be achieved by ZIRCADYNE 702 at temperatures between 500° C. and 800° C. for time periods between 3 hours and 200 hours using air oxidation as the method of oxidation, and more preferably at temperatures between 500° C. and 600° C. for time periods between 20 and 150 hours. A creamy-whitish surface can preferably be achieved by ZIRCADYNE 705 at temperatures between 500° C. and 750° C. at durations between 6 and 200 hours using air oxidation as the method of oxidation, and more preferably at temperatures between 500° C. and 600° C. for time periods between 20 and 140 hours. With a higher oxidation temperature, a shorter oxidation time should be used. For example, for ZIRCADYNE 702 an oxidation temperature of about 600° C. should be held for at least 25 hours, whereas a temperature of around 750° C. is applied only for about 6 hours to achieve a pink ceramic surface. At ZIRCADYNE 705, an oxidation at about 700° C. for about 6 hours and an oxidation at about 600° C. for at least 20 hours lead to a comparably creamy-whitish ceramic surface. With active methods of oxidation such as gassing the oxidation procedure can be influenced, e.g. gassing with oxygen may lead to shorter time periods. Gassing with other elements or combinations of elements may influence the color and quality of the ceramic coating.

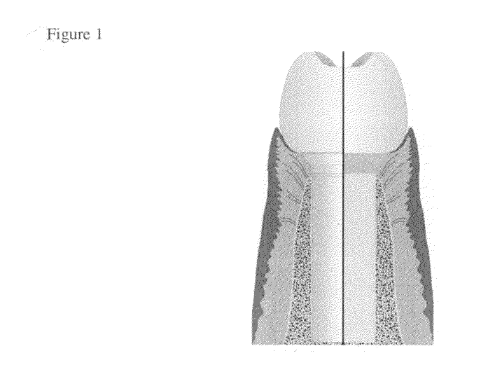

The present method produces a controlled, firmly adhering colored biocompatible ceramic oxide coating on dental, oral and maxillofacial implants, abutments and other prosthetic appliances, preferably with a uniform thickness of more than 20 μm. The morphology of the ceramic surface can be produced and controlled either to be smooth, or with any other surface morphology, such as a rough, textured, grooved, or similar morphology. The outer surface of the device preferably should resemble the color of the surrounding tissues. In case of a bony surrounding the color should be creamy-whitish, whereas in case of a mucosal surrounding (e.g. for the abutment) should be colored like mucosa, meaning pinkish. The creamy-white or whitish color may also be used for the fabrication of tooth-colored restorations like root posts, crowns, bridges, and others (FIG. 1). The formation of the ceramic surface generally increases the mechanical stability of the metal substrate. Therefore, the dental, oral and maxillofacial implants of the present invention provide superb clinical long-term behavior in addition to esthetic benefits.

One further advantage of the ceramic coating is that the oxide layers are grown on the surface of the metal, essentially copying the texture of the metallic surface. A modification of the surface of the metal substrate leads to a modification of the texture of the ceramic oxide surface layer from smooth to rough or morphologically controlled texture. For example, prior to the oxidation, the metallic surfaces can be etched to achieve controlled and homogenous surface roughness. The surfaces may also be laser textured, controlled grooved, grit blasted or machined. All surface morphologies are suitable for the oxidation. Roughening the metallic surface leads to the development of a rough ceramic surface layer. Laser texturing and grooving of the metal leads to a textured and grooved ceramic oxide. This may be beneficial for the biologic integration, since an irregular surface structure accommodates tissue in-growth needed for both, osseous and soft tissue integration of the implants and their components. With our method a controlled integration following the needs of the hard and soft tissues cells can be achieved. Besides dental, oral and maxillofacial implants and abutments, other prosthetic implant components trespassing the mucosa like bars, ball attachments, telescopes, etc. can be made with a color matching the surrounding tissues, like a pinkish colored surface. Frameworks for crowns or bridges, esthetic root posts and other prosthetic appliances can be made with a whitish colored surface.

### EXAMPLES

The following examples are set forth so as to provide those of ordinary skill in the art with a complete disclosure and description of how to make and use the invention and are not intended to limit the scope of the invention. Efforts have been made to ensure accuracy with respect to numbers used (e.g., amounts, temperature, etc.), but some experimental errors and deviations should be accounted for. Unless indicated otherwise, parts are parts by weight, molecular weight is average molecular weight, temperature is in degrees Centigrade, and pressure is at or near atmospheric.

### Example 1

Disk shaped specimens with a thickness of 1 mm were produced. A ceramic covered surface with a whitish or creamy-whitish color suitable for an implant or any kind of prosthetic reconstruction was produced. The ZIRCADYNE 705 specimens were roughened a) by machining and b) by acid etching with a 1% and a 5% concentrated hydroflouric acid for 10, 20 and 30 seconds, respectively and c) by laser texturing. All specimens were cleaned in ethanol in an ultrasonic bath and dried with oil-free air. The specimens were placed in a furnace at room temperature. The furnace was heated up slowly until the desired temperature was reached (1° C. per minute) for oxidizing. After the desired color was reached the furnace was turned off and cooled down at a rate of 1° C. per minute. A whitish color of the surface coating was achieved by the following combinations of temperature/duration of the oxidation procedures:

| Temp. | Oxidation time | Color |
|---|---|---|
| 500° C. | 141 h | whitish/creamy-whitish |
| 530° C. | 66 h | whitish/creamy-whitish |
| 600° C. | 50 h | whitish/creamy-whitish |
| 650° C. | 10 h | whitish/creamy-whitish |
| 700° C. | 6 h | whitish/creamy-whitish |
| 750° C. | 6 h | whitish/creamy-whitish |

The different surface roughnesses produced by the two pretreatment methods a) and b) did not lead to a different outcome of the ceramic coating. Furthermore, the concentration of the acid and duration of the etching procedure did not influence the result. The thickness of the coating achieved by an oxidation at 700° C. after 10 h was approximately 100 μm. The pretreatment method c), however, accelerated the formation of the ceramic oxide. A controlled grooved whitish oxide, mimicking the morphology of the laser textured metal substrate was already achieved after 9 h at 540° C.

For the best result of the whitish colored oxide coating (surface integrity, thickness, color), the oxidation is preferably performed at a low temperature of approximately 500° C. or 530° C., respectively, for the minimum durations mentioned above. The thickness of the layers achieved with these parameters may be increased with longer oxidation, providing a thicker oxide with a more intense color. Higher temperatures lead to a faster development of the oxide layer. The integrity of the surface, however, is reduced due to cracks in the oxide layer.

### Example 2

A ceramic covered surface having a pinkish color for making an implant abutment was made. A disk shaped specimen with a thickness of 1 mm was produced. The ZIRCADYNE 702 specimens were roughened a) by machining, b) by acid etching with a 1% and a 5% concentrated hydroflouric acid for 10, 20 and 30 seconds, respectively, and c) by laser texturing. All specimens were cleaned in ethanol in an ultrasonic bath and dried with oil-free air. The specimens were placed in a furnace at room temperature. The furnace was heated up slowly until the desired temperature was reached (1° C. per minute) for oxidation. After the desired color was reached, the furnace was turned off and cooled down in a rate of 1° C. per minute. A pinkish color of the surface coating was achieved by the following combinations of temperature/duration of the oxidation procedures:

| Temp. | Oxidation time | Color |
|---|---|---|
| 500° C. | 141 h | pinkish |
| 530° C. | 66 h | pinkish |
| 600° C. | 50 h | pinkish |
| 650° C. | 10 h | pinkish |
| 700° C. | 10 h | pinkish |
| 750° C. | 6 h | pinkish |

Acid etching with 5% concentrated hydrofluoric acid led to a better result of the oxide ceramic coating than etching with 1% acid. Furthermore, the duration of the etching had an influence: etching for 30 seconds led to a faster development/growth of the ceramic coating than etching for 10 seconds. The machined surfaces led to a comparable oxide layer as the etched surfaces. The thickness of the coating achieved by oxidation at 700° C. after 10 h was approximately 100 μm. The pretreatment method c) also accelerated the formation of the ceramic oxide. A controlled grooved pinkish oxide, mimicking the morphology of the textured metal substrate was achieved after 9 h at 540° C.

The good result of the colored oxide coating (surface integrity, thickness, color), was achieved at an oxidation temperature of 530° C. at a oxidation time of 66 h. The thickness of the layers achieved with the parameters listed above, can be increased with longer oxidation, leading to a thicker oxide with a more intense color. Higher temperatures lead to a faster development of the oxide layer. However, the coating integrity may be compromised (cracks).

We claim:

1. A dental, oral or maxillofacial implant, implant component or prosthetic appliance comprising an oxide ceramic coating on a metal surface.

2. The dental, oral or maxillofacial implant, implant component or prosthetic appliance of claim 1 wherein the oxide ceramic coating is substantially the color of the surrounding tissue.

3. The dental, oral or maxillofacial implant, implant component or prosthetic appliance of claim 1 wherein the oxide ceramic coating comprises one or more metals selected from the group consisting of Zi, Ti, Nb, and Fe.

4. The dental, oral or maxillofacial implant, implant component or prosthetic appliance of claim 1 wherein the oxide ceramic coating comprises zirconium or a zirconium alloy.

5. The dental, oral or maxillofacial implant, implant component or prosthetic appliance of claim 1 wherein the oxide ceramic coating is at least 20 μm thick.

6. A prosthetic appliance according to claim 1 wherein the appliance is an abutment, ball attachment, bar, telescopic component or the implant itself, trespassing the mucosa.

7. The dental, oral or maxillofacial implant, implant component or prosthetic appliance of claim 1 wherein the external color is substantially whitish or creamy or yellowish or brownish or orange or creamy-whitish or reddish or pinkish.

8. The dental, oral or maxillofacial implant, implant component or prosthetic appliance of claim 1 comprising one or more metals selected from the group consisting of Zi, Ti, Nb, and Fe.

9. The dental, oral or maxillofacial implant, implant component or prosthetic appliance of claim 1 comprising one or more metal or alloy selected from the group consisting of Zirconium, ZIRCADYNE 702, ZIRCADYNE 705, a Zr/Y-alloy, a Zr/Ce-alloy, a Zr/Si alloy, a Zr/Ti alloy, a Zr/Al alloy, a Zr/Mg alloy, a Zr/Fe alloy, and a Zr/N alloy.

10. A method of making a dental, oral or maxillofacial implant, implant component or prosthetic appliance comprising oxidizing the surface of a metal.

11. A method according to claim 10 wherein the morphology of said surface is modified prior to oxidizing.

12. A method according to claim 10 wherein said step of modifying the surface comprises a surface preparation process comprising a step selected from the group consisting of etching, grooving, laser texturing, machining, SLA (sandblasted+acid etched), TPS (titan plasma spray), and anodizing.

13. A method according to claim 10 wherein the etching is performed by applying an acid.

14. A method according to claim 10 wherein the metal comprises one or more metals selected from the group consisting of Zi, Ti, Nb, and Fe.

15. A method according to claim 10 wherein the metal is Zirconium.

16. A method according to claim 15 wherein the Zirconium is selected from the group consisting of substantially pure Zi (ZIRCADYNE 702), Zi-alloy (ZIRCADYNE 705), a Zr/Y-alloy, a Zr/Ce-alloy, a Zr/Si alloy, a Zr/Ti alloy, a Zr/Al alloy, a Zr/Mg alloy, a Zr/Fe alloy, and a Zr/N alloy.

17. A method according to claim 10 wherein the oxidizing is performed at temperatures higher than 400° C. but lower than 900° C. for time periods between 1 and 500 hours.

18. A method according to claim 10 wherein the oxidizing is performed until the surface of the metal reaches substantially the color of the tissue surrounding said implant, component or appliance.

19. A method according to claim 10 wherein the oxidizing is performed until a whitish or creamy or yellowish or brownish or orange or creamy-whitish color is obtained on the surface of the metal.

20. A method according to claim 10 wherein the oxidizing is performed until a reddish or pinkish color is obtained on the surface of the metal.

21. A method according to claim 10 wherein the oxidizing is performed until a ceramic coating is produced wherein the ceramic coating is at least 20 μm thick.

22. A dental, oral or maxillofacial implant, implant component or prosthetic appliance produced by the method of claim 10.
